(19) United States
(12) Patent Application Publication
(10) Pub. No.: US 2004/0145514 A1
(43) Pub. Date: Jul. 29, 2004

(54) Bistatic delay doppler radar altimeter

(76) Inventor: Russell Keith Raney, Annapolis, MD (US)

Correspondence Address: Benjamin Y Roca, Office of Patent Counsel, The Johns Hoplins University, AppliedPhysics Laboratory 11100 Johns Hopkins Road, Laurel, MD, 20723-6099, US

(21) Appl. No.: 10/473,107

(22) PCT Filed: Mar. 25, 2002
(86) PCT No.: PCT/US02/09124

(51) Int. Cl. G01S 13/08; G01S 7/40

(52) U.S. Cl. 342/120; 342/123; 342/174; 342/121

(57) ABSTRACT

Multiple radar altimeters on a constellation of individual satellites in the same orbit plane relate an advanced ocean altimetry system. Earth rotation separates the respective measurement tracks of each satellite on the ocean surface. Each satellite can host a monostatic radar altimeter, which may contain a co-located transmitter and receiver that generates one surface track of ocean height measurements at nadir. Further, each satellite payload can include a bistatic radar altimeter, comprising a transmitter and a receiver located respectively on neighboring satellites. The bistatic altimeter comprises a virtual nadir altimeter that generates an additional surface track of ocean height measurements along the locus of midpoints on the surface between the satellites' nadir points. Delay-Doppler techniques can be used on the bistatic altimeter as well as the monostatic altimeters to reduce each instrument's power and mass requirements, increase measurement precision, sharpen along-track resolution, and reduce the minimum stand-off distance from land.

### CROSS REFERENCE TO RELATED APPLICATIONS

This application is related to and claims the benefit of U.S. Provisional Patent Application Serial No. 60/279,219, filed Mar. 28, 2001 entitled “Bistatic Delay Doppler Radar Altimeter”.

### STATEMENT OF GOVERNMENTAL INTEREST

The invention was made with Government support under cooperative agreement NAS5-97271 with the National Aeronautics and Space Administration (NASA). The government has certain rights in the invention.

### FIELD OF THE INVENTION

The present invention is related to oceanographic altimetry. More specifically, the present invention is related to oceanographic altimetry using a constellation of satellite-based altimeters capable of both nadir and off-nadir measurements of ocean surface heights.

### BACKGROUND OF THE INVENTION

Accurate ocean surface height measurements are of great importance to the scientific community. Ocean study provides tremendous insight to world weather patterns and more. Mesoscale ocean phenomenon (approximately 50-100 km) are both spawned by and can drive mean ocean flow. Oceanic rings, western boundary current meanders, and deep ocean eddies are important in modifying not only the dominant flow over much of an ocean but also in affecting the geochemistry and chemical biological oceanography. Eddy fields transport, entrap, and disperse chemicals, dissolved substances, nutrients, small organisms and particulate matter, and are central to the oceanic energy exchange processes.

Estimates of kinetic energy, Reynolds' stresses, mean and meandering flows of the world's oceans provide for accurate modeling of CO₂ atmosphere-ocean exchange. These estimates also facilitate long-term modeling of large-scale dynamic effects such as the El Nino weather phenomenon.

Presently, there are no means for generating accurate ocean surface height measurements from space at points on the ocean surface other than the nadir point directly below a satellite that houses a radar altimeter. As described above, however, there is a scientific need for more ocean surface height measurements than can be supplied by one or even a few nadir altimeters.

In an effort to provide more sea surface height data, several wide-swath or multi-beam altimeters have been proposed over the past twenty years. The primary problem with such schemes is that they are incapable of meeting the very stringent accuracy requirements of ocean surface topography measurement. Side-looking, wide-swath, or multi-beam altimetry requires some means of triangulation, which is an unnatural way to attempt highly accurate measurement of sea surface heights.

The present invention provides a satellite-based means of oceanic altimetry that can virtually double the coverage of an oceanic altimetry system while at the same time satisfying high accuracy. As an example of present-day accuracy standards, consider TOPEX. The TOPography EXperiment for ocean circulation (TOPEX), a radar altimeter on TOPEX/Poseidon, a cooperative project between the United States and France, was a mission designed to develop and operate an advanced satellite-based radar altimeter to provide global ocean level measurements with an unprecedented accuracy. TOPEX was launched into an orbit 1,336 kilometers (830 miles) above the Earth's surface. The ocean level data from TOPEX are used to determine global ocean circulation and to increase the knowledge of the interaction of the oceans and the atmosphere. TOPEX generates “natural” altimetric ocean level measurements at nadir using either the dual-frequency NASA TOPEX radar or the CNES single frequency SSALT (Poseidon) radar. Since TOPEX and the SSALT share a common antenna, they cannot be operated simultaneously. TOPEX, the primary mission instrument, is operated about 90% of the time, and the SSALT is operated about 10% of the time. TOPEX provides ocean height measurements from satellite to ocean surface with an accuracy of 2.4 centimeters (0.95 inches) for a one second averaging time. TOPEX is an excellent example of a pulse-limited nadir-sensing radar altimeter for ocean observations.

The great virtue of a pulse-limited radar altimeter is that the measurement objective, ocean surface height, is measured directly, subject only to path length corrections and precision orbit determination. That is, the radar range of interest is the minimum range observed in the ensemble of signals reflected back to the radar. There is no need to establish the precise neighborhood giving rise to the reflection, nor to the angle of incidence relative to the radar. Nadir is by definition the closest point to the altimeter, and any change in ocean surface height is manifest as a corresponding change in the minimum range to that point. This may be denoted a “natural” sea surface height measurement.

The same virtue carries over to bistatic measurements of ocean surface height. That is, the radar range of interest is the minimum range observed in the ensemble of reflected signals available to the radar. Just as in nadir altimetry, for bistatic height measurements there is no need to establish the precise area on the surface that gives rise to the reflection, nor to the angles of incidence or reflection relative to the radars. For a nominally horizontal surface, the specular point is by definition at the minimum reflected range between the two satellites. Any change in ocean surface height is manifest as a corresponding change in the minimum range of all rays reflected from the neighborhood of that point. Thus, a bistatic radar supports natural height measurement in direct parallel to pulse-limited nadir height measurements.

The situation is very different for any scheme that would attempt to measure ocean surface height through reflections gathered in a side-looking backscatter geometry. A wide swath altimeter is one example of such a configuration. In the side-looking case, extraction of ocean surface height from radar range data requires that the angle from the radar to the ocean's surface be known, indeed, very well known. In the side-looking backscatter mode, radar range increases monotonically with time, and with incident angle. There is no minimum in the range data that could robustly establish the height measurement point in the absence of additional information. If very accurate ocean surface heights are required, in a side-looking backscatter geometry then extremely accurate knowledge is required of the incident angle at the point of measurement. Height measurement in a side-looking geometry is by definition a problem in triangulation, rather than a minimum distance. Triangulation introduces new uncertainties, and these induce new sources of ocean surface height error. Triangulation is considered to be an unnatural measurement if accuracy is required.

Being an unnatural measurement, wide swath altimetry starts with a fundamental disadvantage that is difficult to fully overcome. There is no known way to meet the angle knowledge requirement by direct means. The required tolerances fall approximately two orders of magnitude beyond current hardware capabilities. Thus, the implied systematic errors in off-nadir unnatural height measurements must be met by indirect methods. Those methods include extensive temporal and spatial averaging. This averaging in effect is a low-pass filter. The end product of height fields may well have data postings at relatively close spacings and reduced variance, but only those signals that pass through the averaging filter will be portrayed.

Coordinated multiple nadir-sensing altimeters have long been acknowledged as the only way to achieve significant improvement in temporal and spatial topographic sampling of global oceans, while simultaneously maintaining height accuracy. In spite of their appealing and substantial science value, multiple satellite solutions have always been considered unrealistic as cost prohibitive. The cost barrier can be substantially reduced, however, if the altimeters can be deployed simultaneously with only one launch vehicle, and if each individual satellite is sufficiently small and low cost. Delay Doppler altimeters in a nadir-viewing satellite constellation meet both conditions making viable a multi-satellite-based system of ocean altimetry. An altimeter typically generates sufficiently accurate ocean surface height data only along its track at nadir. Thus, the number of tracks is equivalent to the number of altimeters, if only the nadir viewing geometry is exploited, the so-called monostatic mode. The essential attribute for scientific applications is the number of tracks along which accurate height measurements can be obtained, not the number of satellites. So, if a satellite pair is equipped with bistatic radar altimeters in addition to the monostatic nadir radar altimeter, then another track can be generated mid-way between the nadir tracks of any two neighboring satellites. The measurement accuracies realized in a bistatic mode are comparable to those observed in a nadir mode, because the bistatic heights are derived from minimum range measurements, and thus are naturally accurate in fashion similar to height measurements by a pulse-limited altimeter at nadir. If nadir and bistatic altimeters are combined, then (n) satellites can generate (2n−1) measurement tracks of accurate sea surface height data along the ocean's surface, almost doubling the effective number of tracks of height data available from a given number of satellites.

### SUMMARY

The present invention relates to multiple radar altimeters on two or more individual satellites in the same orbit plane. Earth rotation separates their respective measurement tracks on the earth's surface. In a monostatic version, each satellite includes a co-located transmitter and receiver and each satellite generates one track, at nadir, as is standard in pulse-limited ocean altimetry. Each nadir altimeter uses two frequencies to mitigate ionospheric path delays, and a three-frequency radiometer to estimate and subsequently mitigate wet atmosphere propagation delays. Delay-Doppler techniques can be used to reduce each instrument's power and mass requirements, increase measurement precision, sharpen along-track resolution, and reduce the minimum stand-off distance from land.

In a bistatic version, each satellite may include a transmitter and receiver located respectively on neighboring satellites. This bistatic altimeter can generate an additional measurement track at the midpoint on the surface between nadir tracks of the two host satellites. Like nadir altimetry, the bistatic geometry supports “natural” measurements, in the sense that the ocean surface heights are derived from the minimum of the waveform's range history. This is in distinct contrast to the off-nadir geometry of a wide-swath or multi-beam altimeter, which generate “unnatural” measurements, since in that disadvantageous geometry the off-nadir ocean surface heights must be extracted from triangulation.

In general, a bistatic constellation of (n) satellites can generate (2n−1) surface tracks of accurate height data. The sub-satellite tracks may be separated in proportion to the inter-satellite orbital spacing. Satellite spacing on-orbit can be selected by design to satisfy a variety of beneficial solutions to the time/space sampling trade-off that is inherent to satellite-based altimetry. At maximum latitudes the surface tracks coincide if all satellite-based altimeters are in the same inertial plane. At these orbital positions, all altimeters (both the nadir-viewing and the bistatic-viewing instruments) measure the height of the same patch of sea surface. These height measurements should agree. Any systematic disagreement provides a direct measure of the differential height measurement errors across the set of altimeters. This fact can be used to cross-calibrate the height measurement of the entire constellation. Once so calibrated, data from the satellite altimeter constellation can support measurement of the cross-track components of the surface gradient as well as the conventional along-track component. All nadir and bistatic data support wind speed, significant wave height, and ocean surface height measurements with conventional algorithms and TOPEX-class accuracies.

### BRIEF DESCRIPTION OF THE DRAWINGS

FIG. 1 illustrates a four satellite constellation in which each satellite includes a monostatic nadir altimeter and components of bistatic virtual nadir altimeters.

FIG. 2 illustrates the basic simplified bistatic geometry.

FIG. 3 illustrates an along-track and cross-track surface measurement grid that can be achieved by co-planar satellite-based radar altimeters according to the present invention.

FIG. 4 illustrates a simplified bistatic geometry for explaining clock error correction and height difference correction.

### DETAILED DESCRIPTION

The present invention provides a means for nearly doubling the number of ocean surface tracks that can yield “natural” ocean surface height measurements as compared to currently existing systems, such as TOPEX. Currently existing systems can obtain accurate “natural” measurements only at the nadir point directly beneath a satellite housing a radar altimeter. Thus, each satellite can only generate data along only one track on the earth's surface. This can be termed a monostatic nadir-sensing altimeter.

The present invention, in its simplest embodiment, incorporates a bistatic radar altimeter into the system. A minimum of two satellites is required to host the bistatic instrument. Each bistatic altimeter comprises two parts: a transmitter on one satellite, and a receiver on an adjacent satellite. The bistatic altimeter generates a record of ocean surface heights along a surface track midway between the nadir tracks of the satellites. The bistatic surface track in effect is generated by a “virtual nadir-sensing altimeter” located mid-way on-orbit between the two satellites that comprise the bistatic pair. Each satellite would be host to a nadir-sensing altimeter, and its half of the bistatic altimeter. In this way, radar altimeters hosted on two satellites can generate three tracks of sea surface height, one from each of the two nadir-sensing altimeters, and one from the bistatic altimeter. Along all three of these tracks, the measured sea surface heights are accurate, due primarily to the fact that all three are natural (minimum range) measurements.

A bistatic radar altimeter is one in which the transmitter and the receiver are located separately, in this case on different widely spaced satellites. Bistatic-mode ocean surface height measurements can sustain accuracies comparable to those of the nadir mode. Bistatic measurements focus on the specular midpoint between the transmitter and the receiver. The specular point is located at the minimum radar range between the two satellites, and its forward reflection (towards the receiver) is very strong. Knowledge of the precise range or incident angle of the specular point is not required, since the ocean surface height is contained in the minimum range observed in the reflected signal. The Doppler properties of reflections from the neighborhood of the specular point are equivalent in principle to those at nadir, so that all advantages of the delay-Doppler paradigm carry over to the bistatic case.

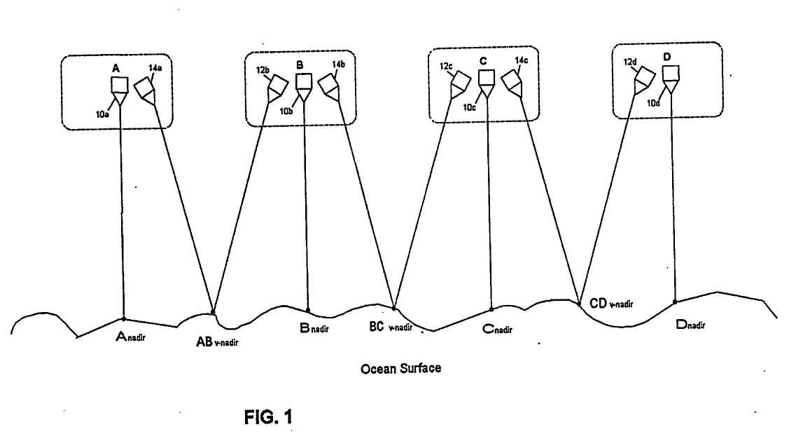

FIG. 1 is an illustration of a four-satellite constellation in which each satellite includes a monostatic nadir altimeter and bistatic (virtual nadir) altimeters. The tracks that each altimeter can generate are also illustrated. Four satellites (A,B,C,D) each possess a nadir altimeter (10a-d), trailing bistatic altimeter components (12a-d), and components of the leading bistatic altimeter (14a-d). Each nadir altimeter is capable of generating an ocean surface height measurement at its nadir point (e.g., A_{nadir}). In addition, each trailing bistatic altimeter works in conjunction with the adjacent leading bistatic altimeter to generate an ocean surface height measurement at a virtual nadir point (e.g., AB_{v-nadir}) midway between the satellite pair. Thus, a four-satellite constellation can generate ocean surface height measurements along seven quasi-parallel tracks. In general, n satellites equipped with nadir and bistatic altimeters would generate (2n−1) accurate ocean surface measurement tracks.

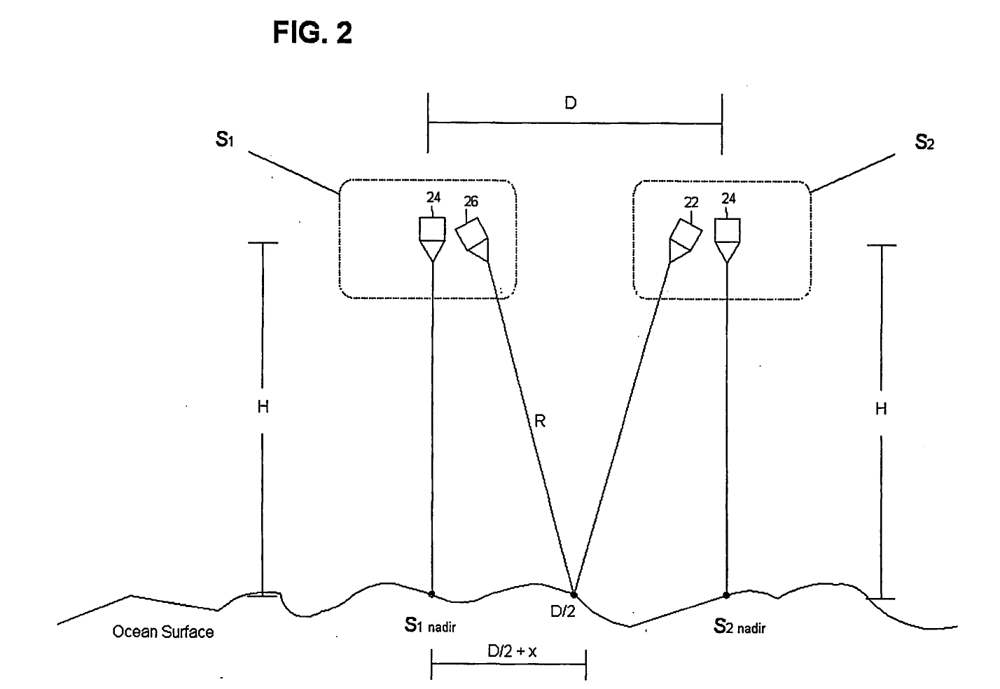

In the simplest two-satellite bistatic configuration, as shown in FIG. 2, each satellite, S₁ and S₂, hosts one and one-half radar altimeters, monostatic and bistatic, respectively. In each satellite, the monostatic altimeter 24 views the nadir points, S1_{nadir} and S2_{nadir} respectively. The bistatic altimeter (22, 26), whose components are shared between the two spacecraft, illuminates the nominal specular point, D/2, on the surface midway between the fore and aft neighboring satellites in the constellation. In a typical embodiment, the nadir altimeters would have two frequencies (to mitigate ionospheric propagation delay) and a microwave radiometer (to mitigate propagation delays through the wet atmosphere). The bistatic instruments typically use one frequency, and do not necessarily include radiometers. The necessary atmospheric and ionospheric path-length corrections to the bistatic legs are extrapolated from the nadir instruments, as there always is sufficient data available from the nadir measurements. Further, each satellite pair maintains knowledge of their spacing, D, to within a few centimeters.

The expected performance of a bistatic sea-surface height measurement generated from two co-planar radar altimeters is presented using a flat earth model for ease of illustration. One of ordinary skill in the art can readily extend the following principles to an orbital geometry in order to characterize a flight system more accurately. Each satellite is at a height, H, above the earth and spaced a distance, D, from its bistatic partner. Each satellite includes a nadir-sensing altimeter in addition to its portion of a bistatic altimeter. The bistatic altimeter on one satellite illuminates the nominal specular point on the surface in the neighborhood of D/2 in the plane of the two satellites. The bistatic altimeter on the other satellite receives the signal. Three first-order issues arise when considering a bistatic mode of operation. The first issue is the sensitivity to small height variations (dH meters relative to H meters, the measurement objective) on sea surface heights deduced for the specular point, D/2. The second issue is the range (phase) behavior on small departures (x) within the range plane from the specular point, D/2. The third issue is the impact of location knowledge errors of the specular point, D/2, and the parameters H and D on height measurement errors.

The bistatic range R(H,x) for this example is:

$$R ( H , x ) = \frac{1}{2} ( \sqrt{{( H )}^{2} + {( \frac{D}{2} + x )}^{2}} + \sqrt{{( H )}^{2} + {( \frac{D}{2} - x )}^{2}} ) \qquad ( 1 )$$

For convenience, define the parameters C and a according to

$${C}^{2} = {( H )}^{2} + ( {D}^{2} / 4 ) ; a = \frac{1}{{C}^{2}} ( 1 - \frac{{D}^{2}}{4 {C}^{2}} ) \qquad ( 2 )$$

Then it can be shown, complete to terms in second order in x and H, that

$$R ( H , x ) = C ( 1 + a \frac{{x}^{2}}{2} ) \qquad ( 3 )$$

With respect to the first issue, sensitivity to small height variations (dH), the response is

$$\frac{ⅆ R}{ⅆ H} = \frac{1}{\sqrt{1 + \frac{{D}^{2}}{4 {H}^{2}}}} \qquad ( 4 )$$

The height measurement at surface position D/2 is derived from and proportional to R, Hence, equation 4 shows that the height measurement, to first order, has sensitivity in the bistatic mode that is comparable to that realized for nadir sensing (in which case D=0). For instance, if D˜H, then the range measurement sensitivity of the bistatic altimeter is within by approximately 10% of that of the nadir altimeters. Mitigating height errors (due to imperfect knowledge of satellite spacing (D), orbit height, differential path delays within the altimeters, or any other systematic cause) is discussed in more detail later.

With respect to the second issue, range variation (Equation 3) is quadratic in x in response to small departures x from the specular point, just as in the nadir case. For comparison, at nadir, recall that the corresponding quadratic phase term in the monostatic case behaves as

$$\frac{{x}^{2}}{H} \qquad ( 5 )$$

which is the starting point for delay Doppler processing. The difference between the nadir case and the bistatic case resides only in the multiplicative parameters, whose values can be well known. Thus, delay Doppler processing, and its attendant advantages, well-known in the nadir (monostatic) case, applies equally well to the bistatic (virtual-nadir) case.

In addition, bistatic height measurement depends on minimum range, at which x=0 in Equation 3. Thus, the bistatic range estimation is a “natural” measurement, as opposed to a triangulation geometry in which height measurement depends to first order on very accurate knowledge of a second variable, e.g., incident angle in a wide swath back-scattered scenario. Such side-looking back-scattering geometries are unnatural frames in which to derive height measurements that must be accurate to centimeters.

With respect to the third issue, the accuracy of the bistatic height measurement (Equation 3) does not depend on precise knowledge of the location of the specular point. Knowledge of its neighborhood is sufficient. After that, the height measurement follows directly from measurement of the minimum range observed in that neighborhood. Thus, the bistatic height measurement is naturally robust.

The sensitivity of the bistatic height measurement to knowledge of the nadir height, H, of each satellite, is to first order. Since H is measured directly at each satellite, the error introduced by this measurement is minimal. Moreover, the bistatic height measurement can be interpreted as the height at the specular point D/2 relative to heights measured at the respective nadirs. Thus, the impact of systematic height error on the accuracy of the bistatic height measurement is minimal.

Errors in the knowledge of satellite separation D can be significant. If D is of the same order of magnitude as the altitude H, then the value of D must be determined to an accuracy on the order of centimeters to sustain sea surface height accuracy of a few centimeters at the bistatic reflection point. This implies that there should be an accurate ranging communication link between each of the two satellites that comprise a bistatic pair. In a coplanar constellation, sensitivity to errors in knowledge of D can be substantially mitigated, according to the method of [0046] and related paragraphs.

A two-dimensional geostrophic current can be derived if two orthogonal components of the surface height gradient can be observed. To date, satellite radar altimeters have been limited to measuring only one orthogonal component of the surface height gradient, namely, the along-track component. The present invention overcomes that limitation by using a constellation of co-planar satellite radar altimeters. Typically, the satellites are at an altitude of 600 kilometers or more, and they are spaced apart by several hundred kilometers along their common orbit plane. As these satellites progress along their orbit, the Earth rotates beneath them. Consequently, the sub-satellite tracks from both the monostatic (nadir-viewing) and bistatic (virtual nadir-viewing) altimeters are laterally separated. Height measurements along neighboring tracks occur within minutes of each other. In particular, these data can be used to estimate the cross-track surface gradient as well as the usual along-track gradient. This is better illustrated in FIG. 3 in which a constellation of three satellites (S1, S2, and S3) are presented spaced apart along their orbital path over a portion of the Earth's surface 32. The record of height measurements from each altimeter follows a track on the Earth's surface that over time is progressively shifted away from the orbit plane by the Earth's rotation. The three-satellite constellation shown in FIG. 3 generates five such height measurement tracks, three tracks (A_{nadir}, B_{nadir}, and C_{nadir}) that correspond to the monostatic altimeters, and two tracks (AB_{v-nadir} and BC_{v-nadir}) each of which correspond to its associated bistatic (virtual) altimeter 34.

Track separation can be adjusted during mission operations through the selection and maintenance of inter-satellite spacing. Thus, measurement of the two-dimensional surface gradient can be optimized during a single flight mission. Sea surface height (SSH) data for both the monostatic and the bistatic measurements are natural measurements, and hence they enjoy the accuracy inherent to pulse-limited geometry. Since all the satellites are co-planar, their surface tracks coincide at their latitude extremes. Height data from all measurements should agree at these points. This fact can be used to cross-calibrate all of the height measurements.

Consider a co-planar two-satellite radar altimeter constellation that uses both the nadir-sensing and the bistatic-sensing modes to measure surface heights. One objective of such a bistatic constellation is to measure directly the cross-track sea-surface slope, a measurement that requires taking the difference between the heights measured independently along parallel surface tracks. Differential clock offset between the satellites, and systematic track-to-track height differences are the two dominant errors that impair the accuracy of these height measurements. In the bistatic mode, a difference of only 0.1 nanosecond between the reference time frame on two separate satellite accurate measurement translates into a height error on the order of two centimeters is unacceptable for accurate measurement. Likewise, a differential height error of only one centimeter between two parallel altimeter surface tracks separated by 10 km leads to a cross-track slope error of one microradian. Again, this would be unacceptable for most applications, especially estimation of vector geostrophic currents. Likewise, an error in knowledge of the baseline D of only a few centimeters would have similar disadvantageous effect.

Systematic timing and height error sources can be readily mitigated, however. In a bistatic configuration, each of the altimeters in sequence traverse essentially the same patch of the ocean surface at their latitudinal extrema. Height data from these points are sufficient to identify systematic differential height measurement errors across the constellation, for both the nadir and the bistatic modes. Once quantified, these errors can be compensated during processing as a part of the algorithm that is applied to derive cross-track slopes, for example. Errors from differential clock offset can also be identified and eliminated. The solution is to implement the bistatic link in both directions. That is, the bistatic altimeters on each satellite comprise both a transmitter and a receiver, rather than just one half of a radar at each end of the link as is generally the case with a basic bistatic radar.

A simple altimeter constellation is sketched in FIG. 4. The two nadir-sensing radar altimeters (A₁ and A₂) deduce their heights from the measured time delays τ₁ and τ₂ respectively. The bistatic radars deduce the surface height beneath a virtual nadir-sensing radar altimeter located mid-way between the two real satellites. The observed bistatic time delays are τ₁₂ and τ₂₁, respectively, after conversion to the equivalent round trip time delay that would be observed from the position of the virtual satellite.

Let the nadir altimeter A₁ serve as the reference. Then at A₁ the measured round-trip time delay τ₁ and the local clock reference t₀ may be assumed to be near “perfect”. Any error at this level will be constant across the ensemble, and therefore will not impact the differential error analysis of this discussion. Thus, our objective is to find t₀ (Δτ₁) across all measurement paths.

Let the clock on A₂ be ahead of the clock on A₁ by an unknown of δt seconds. Let the round-trip delay observed at A₂ be longer by an unknown δτ seconds than would be observed from Aₜ if it were to make the same height measurement. This systematic round-trip delay offset could be due to imperfect knowledge of the radii of the orbits, differences in the instruments' path length delays, or any other quasi-constant cause.

A similar set of systematic round-trip delay errors impact the bistatic measurements. In addition, a systematic imperfect knowledge of the spacing between the host satellites would translate into a systematic height error along the virtual nadir (bistatic-derived) track. In the following, all bistatic timing measurements are scaled according to the incident geometry so that the numbers reflect data that would be collected by an equivalent (virtual) altimeter located at the midpoint between the two nadir altimeters. The instrument-specific delays in general will be different for each direction, leading to an unknown delay error of δτ₁₂ when transmitting from A₁ and receiving at A₂, and, conversely, δτ₂₁ from A₂ to A₁.

The four time delay measurements then may be written in the following forms.

| | |
|---|---|
| A₁, nadir: | τ₁ = t₀ + τ₀ − t₀ = τ₀ |
| A₂, nadir: | τ₂ = (t₀ + δt) + τ₀ + δτ − (t₀ + δt) = τ₀ + δτ |

| | |
|---|---|
| A₂, bistatic: | τ₁₂ = (t₀ + δt) + τ₀ + δτ₁₂ − t₀ = τ₀ + δt + δτ₁₂ |
| A₁, bistatic: | τ₂₁ = t₀ + τ₀ + δτ₁₂ − (t₀ + δt) = τ₀ − δt + δτ₂₁ |

In each bistatic link there is an error δt due to lack of perfect synchronicity between the clocks at the transmitter and the receiver. Such a differential clock error if left uncorrected would render the bistatic mode to be less useful for the precision range measurements required for ocean radar altimetry.

### Clock Error Correction

The solution is to exercise the bistatic link in both directions, in which case there is no need for perfect agreement between the two clocks. The desired delay measurement τᵥ is derived from both bistatic measurements by averaging, according to

Virtual nadir: τᵥ=(τ₁₂+τ₂₁)/2=τ₀+(δτ₁₂+δτ₂₁)/2

This result has the virtue that the differential clock offset error δt has been eliminated. Thus, there is no need to maintain rigorous synchronicity between the time references that govern the two satellites.

### Systematic Height Difference Correction

After correction for the bistatic clock difference, the delay measurements form a set comprising

| | |
|---|---|
| A₁, nadir: | τ₁ = τ₀ |
| A₂, nadir: | τ₂ = τ₀ + δτ |
| Virtual nadir: | τ_{V} = τ₀ + (δτ₁₂ + δτ₂₁)/2 |

The altimeters in a constellation are co-planar, so their footprints converge with increasing latitude, finally overlapping at the north and south latitudes of the orbit's inclination angle. Therefore, when passing over the ocean at maximal latitude, these altimeters observe essentially the same ocean-surface-to-satellite height. It follows that their respective height measurements should be the same. Data at those points provide a direct estimate of the total delay offsets relative to the reference height. Thus, the systematic delay error at A₂ relative to that at A₁ is observable, and equal to δτ. For the virtual nadir measurement, the relative systematic delay offset also is observable, and equal to (δτ₁₂+δτ₂₁)/2.

The same self-calibration strategy can be repeated twice each orbit when the latitudinal extrema pass over the ocean in the northern and southern hemispheres. Once the relative systematic differences are determined, they can be compensated (nominally by subtraction) for all data over the entire orbit.

These corrections are essentially perfect as long as the underlying cause for the observed difference remains constant. For example, if there is a relative lead or lag of one clock over the other, that is perfectly acceptable, as long as that mismatch is stable over the round trip pulse propagation time, which is on the order of 10 ms for this class of radars. In the event that there is a drift between the two satellites' clocks, the accuracy of the method suggested here is limited by the rate of that drift. Given the stability of typical spacecraft clocks, however, the solution herein disclosed should be more than sufficient to support the centimeter-level accuracies expected of modern radar altimetry.

The same constancy caveat applies to systematic across-track differential height errors. Here, however, there are more sources of potential change in offset over the orbit. Hence, differential height offsets measured at maximal latitudes are not necessarily perfect corrections for data from other portions of the orbit. For example, after measuring and removing the “constant” differential height offsets, the leading error source most likely will prove to be limited knowledge of the geoid along the less-conventional orbits that must be followed by all but one of a co-planar constellation.

In contrast to other means of generating wider temporal and spatial coverage by ocean altimeters, the present invention is inherently accurate, and self-calibrating. The present invention offers a flexible, capable, unique, and cost-effective approach that would significantly advance the state-of-the-art of satellite radar altimetry.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A radar altimeter system comprising:
in a first satellite:
a first monostatic radar altimeter for determining an ocean surface height measurement at the nadir point on the ocean surface directly beneath the first satellite; and
a first bistatic radar altimeter including a transmitting component for transmitting a bistatic signal, in a second satellite that is in a coplanar orbit with said first satellite:
a first monostatic radar altimeter for determining an ocean surface height measurement at the nadir point on the ocean surface directly beneath the second satellite; and
a first bistatic radar altimeter including a receiving component for receiving said transmitted bistatic signal,
such that a bistatic ocean surface height measurement at a virtual nadir point on the ocean surface that is directly beneath an orbital point that is half the distance between said first and second satellites is determinable.

2. The system of claim 1 wherein the bistatic ocean surface height measurement is determined using delay Doppler techniques.

3. The system of claim 1 wherein said first bistatic radar altimeter in said first satellite further comprises a receiving component and said first bistatic radar altimeter in said second satellite further comprises a transmitting component such that a bi-directional transmit/receive link is established between the first bistatic altimeter in the first satellite and the first bistatic altimeter in the second satellite in order to minimize any timing error between measurements taken on different satellites that could affect the accuracy of the bistatic ocean surface height measurement.

4. The system of claim 1 further comprising cross calibrating height measurements from the monostatic and bistatic radar altimeters in each satellite by comparing the observed ocean surface height measurements when each satellite sequentially reaches its maximal latitude and illuminates the same region on the ocean surface, thereby providing a reference common to all said altimeters.

5. A radar altimeter system comprising:
in a leading satellite:
a first monostatic radar altimeter for determining an ocean surface height measurement at the nadir point on the ocean surface directly beneath the leading satellite;
a first bistatic radar altimeter including a transmitting component for transmitting a bistatic signal;
a second bistatic radar altimeter including a receiving component for receiving a bistatic signal,
in a middle satellite that is in a coplanar orbit with said leading satellite:
a first monostatic radar altimeter for determining an ocean surface height measurement at the nadir point on the ocean surface directly beneath the middle satellite;
a first bistatic radar altimeter including a receiving component for receiving said transmitted bistatic signal from said first bistatic radar altimeter in said leading satellite;
a second bistatic radar altimeter including a transmitting component for transmitting a bistatic signal,
in a trailing satellite that is in a coplanar orbit with said leading and middle satellites:
a first monostatic radar altimeter for determining an ocean surface height measurement at the nadir point on the ocean surface directly beneath the trailing satellite;
a first bistatic radar altimeter including a receiving component for receiving said transmitted bistatic signal from said second bistatic radar altimeter in said middle satellite;
a second bistatic radar altimeter including a transmitting component for transmitting a bistatic signal,
such that bistatic ocean surface height measurements at virtual nadir points on the ocean surface directly beneath orbital points that are half the distance between said leading and middle satellites and said middle and trailing satellites are determinable.

6. The system of claim 5 wherein bistatic ocean surface height measurements are determined using delay Doppler techniques.

7. The system of claim 5 wherein,
said first bistatic radar altimeter in said leading satellite further comprises a receiving component and said first bistatic radar altimeter in said middle satellite further comprises a transmitting component such that a bi-directional transmit/receive link is established between the first bistatic altimeter in the leading satellite and the first bistatic altimeter in the middle satellite in order to minimize any timing error between measurements taken on different satellites that could affect the accuracy of the bistatic ocean surface height measurement observed between said leading and middle satellites; and
said second bistatic radar altimeter in said middle satellite further comprises a receiving component and said first bistatic radar altimeter in said trailing satellite further comprises a transmitting component such that a bi-directional transmit/receive link is established between the second bistatic altimeter in the middle satellite and the first bistatic altimeter in the trailing satellite in order to minimize any timing error between measurements taken on different satellites that could affect the accuracy of the bistatic ocean surface height measurement observed between said middle and trailing satellites.

8. The system of claim 5 further comprising cross calibrating height measurements from the monostatic and bistatic radar altimeters in each satellite by comparing the observed ocean surface height measurements when each satellite sequentially reaches its maximal latitude and illuminates the same point on the ocean surface, thereby providing a reference common to all said altimeters.

9. A radar altimeter system comprising:
in a leading satellite:
a first monostatic radar altimeter for determining an ocean surface height measurement at the nadir point on the ocean surface directly beneath the leading satellite;
a first bistatic radar altimeter including a transmitting component for transmitting a bistatic signal;
in a middle satellite that is in a coplanar orbit with said leading satellite:
a first monostatic radar altimeter for determining an ocean surface height measurement at the nadir point on the ocean surface directly beneath the middle satellite;
a first bistatic radar altimeter including a receiving component for receiving said transmitted bistatic signal from said first bistatic radar altimeter in said leading satellite;
a second bistatic radar altimeter including a transmitting component for transmitting a bistatic signal,
in a trailing satellite that is in a coplanar orbit with said leading and middle satellites:
a first monostatic radar altimeter for determining an ocean surface height measurement at the nadir point on the ocean surface directly beneath the trailing satellite;
a first bistatic radar altimeter including a receiving component for receiving said transmitted bistatic signal from said second bistatic radar altimeter in said middle satellite;
such that bistatic ocean surface height measurements at virtual nadir points on the ocean surface directly beneath orbital points that are half the distance between said leading and middle satellites and said middle and trailing satellites are determinable.

10. The system of claim 9 further comprising cross calibrating height measurements from the monostatic and bistatic radar altimeters in each satellite by comparing the observed ocean surface height measurements when each satellite sequentially reaches its maximal latitude and illuminates the same point on the ocean surface, thereby providing a reference common to all said altimeters.

11. A bistatic surface height measurement method comprising:
determining an ocean surface height measurement from a first satellite at the nadir point on the ocean surface directly beneath the first satellite via a first monostatic radar altimeter;
determining an ocean surface height measurement from a second satellite that is in a coplanar orbit with said first satellite at the nadir point on the ocean surface directly beneath the second satellite via a second monostatic radar altimeter;
transmitting, from a first bistatic radar altimeter on said first satellite, a signal aimed generally at the specular point on the ocean surface between said first and second satellites
receiving, in a second bistatic radar altimeter on said second satellite, said transmitted signal; and
determining a bistatic ocean surface height measurement at a virtual nadir point on the ocean surface that is directly beneath an orbital point that is half the distance between said first and second satellites using data obtained by said monostatic radar altimeters and said bistatic radar altimeters on said first and second satellites.

12. The method of claim 11 wherein the bistatic ocean surface height measurement is determined using delay Doppler techniques.

13. The method of claim 11 further comprising:
transmitting, from said second bistatic radar altimeter on said second satellite, a signal aimed generally at the specular point on the ocean surface between said first and second satellites
receiving, in said first bistatic radar altimeter on said first satellite, said transmitted signal,
such that a bi-directional transmit/receive link is established between the first bistatic radar altimeter in the first satellite and the second bistatic radar altimeter in the second satellite in order to minimize any timing error between measurements taken on different satellites that could affect the accuracy of the bistatic ocean surface height measurement.

14. The method of claim 11 further comprising cross calibrating height measurements from the monostatic and bistatic radar altimeters in each satellite by:
comparing the observed ocean surface height measurements when each satellite sequentially reaches its maximal latitude and illuminates the same point on the ocean surface, thereby providing a reference common to all said altimeters.
